(19) United States
(12) Patent Application Publication
(10) Pub. No.: US 2026/0025488 A1
(43) Pub. Date: Jan. 22, 2026

(54) CONTROL METHOD AND PROJECTION APPARATUS

(71) Applicant: SEIKO EPSON CORPORATION, Tokyo (JP)

(72) Inventors: Yutaro IIJIMA, Matsumoto-shi (JP); Shoichi KINOSHITA, Beppu-shi (JP)

(73) Assignee: SEIKO EPSON CORPORATION, Tokyo (JP)

(21) Appl. No.: 19/275,472

(22) Filed: Jul. 21, 2025

(30) Foreign Application Priority Data
Jul. 22, 2024 (JP) 2024-116765

(51) Int. Cl. H04N 9/31

(52) U.S. Cl. CPC H04N 9/3185; H04N 9/3194

(57) ABSTRACT

A method for controlling a projection apparatus configured to project an image onto a projection receiving surface, a first period containing a second period, the method including: determining based on an output from a first sensor that a movement of the projection apparatus stops when a state in which a parameter value indicating the movement is smaller than a first threshold continues for the first period; detecting at least one depth map indicating a distance from a second sensor to each of multiple positions on the projection receiving surface based on an output from the second sensor in at least a portion of the first period; identifying an orientation of the projection apparatus with respect to the projection receiving surface based on the at least one depth map; and correcting distortion of the image based on the orientation when it is determined that the movement stops.

The present application is based on, and claims priority from JP Application Serial Number 2024-116765, filed Jul. 22, 2024, the disclosure of which is hereby incorporated by reference herein in its entirety.

### BACKGROUND

### 1. Technical Field

The present disclosure relates to a control method and a projection apparatus.

### 2. Related Art

The projector according to JP-A-2003-295321 includes a detector that detects and notifies that movement of a body of the projector has stopped and a trapezoidal distortion corrector that, when the detector notifies that movement of the body of the projector has stopped, starts trapezoidal distortion correction according to the relative positional relationship between the projector after the movement and a projection receiving surface.

JP-A-2003-295321 is an example of the related art.

In the related art, since measurement of information necessary for performing geometric correction such as trapezoidal distortion correction is not started until a condition that triggers the geometric correction is satisfied, there is a problem of a long period required to complete the geometric correction. Detecting that the movement of the body of the projector has stopped, that is, the stationary state thereof is an example of the condition that triggers the geometric correction.

### SUMMARY

A control method according to a first aspect of the present disclosure is a method for controlling a projection apparatus configured to project an image onto a projection receiving surface, the method including: determining based on an output from a first sensor that a movement of the projection apparatus stops when a state in which a parameter value indicating the movement is smaller than a first threshold continues for a first period; detecting at least one depth map indicating a distance from a second sensor to each of multiple positions on the projection receiving surface based on an output from the second sensor in at least a portion of the first period; identifying an orientation of the projection apparatus with respect to the projection receiving surface based on the at least one depth map; and correcting distortion of the image based on the orientation when it is determined that the movement stops.

A control method according to a second aspect of the present disclosure is a method for controlling a projection apparatus configured to project an image onto a projection receiving surface, the method including: receiving an instruction indicating correction of distortion of the image via an operation device configured to operate the projection apparatus; detecting at least one depth map indicating a distance from a sensor to each of multiple positions on the projection receiving surface based on an output from the sensor; identifying an orientation of the projection apparatus with respect to the projection receiving surface based on the at least one depth map detected in at least a second period from a first time point at which the instruction is received to a second time point before the first time point; and correcting distortion of the image based on the orientation when the instruction is received via the operation device.

A projection apparatus according to a third aspect of the present disclosure is a projection apparatus including one or more processors and configured to project an image onto a projection receiving surface, wherein the one or more processors are configured to determine based on an output from a first sensor that a movement of the projection apparatus stops when a state in which a parameter value indicating the movement of the projection apparatus is smaller than a first threshold continues for a first period; detect at least one depth map indicating a distance from a second sensor to each of multiple positions on the projection receiving surface based on an output from the second sensor in at least a portion of the first period; identify an orientation of the projection apparatus with respect to the projection receiving surface based on the at least one depth map; and correct distortion of the image based on the orientation when it is determined that the movement stops.

### BRIEF DESCRIPTION OF THE DRAWINGS

FIG. 1 is a block diagram showing an example of the configuration of a projection apparatus.

FIG. 2 illustrates examples of the operations of a determination section, a detection section, an identification section, and a correction section.

FIG. 3 illustrates examples of the operations of the determination section, the detection section, the identification section, and the correction section.

FIG. 4 illustrates examples of the operations of the determination section, the detection section, the identification section, and the correction section.

FIG. 5 illustrates examples of the operations of the determination section, the detection section, the identification section, and the correction section.

FIG. 6 illustrates examples of the operations of the determination section, the detection section, the identification section, and the correction section.

FIG. 7 is a flowchart showing an example of the operation of the projection apparatus.

FIG. 8 is a block diagram showing an example of the configuration of the projection apparatus.

FIG. 9 illustrates examples of the operations of the determination section, the detection section, the identification section, and the correction section.

FIG. 10 illustrates examples of the operations of the determination section, the detection section, the identification section, and the correction section.

FIG. 11 is a flowchart showing an example of the operation of the projection apparatus.

FIG. 12 is a block diagram showing an example of the configuration of the projection apparatus.

FIG. 13 illustrates examples of the operations of the determination section, the detection section, the identification section, and the correction section.

FIG. 14 illustrates examples of the operations of the determination section, the detection section, the identification section, and the correction section.

FIG. 15 is a flowchart showing an example of the operation of the projection apparatus.

### DESCRIPTION OF EMBODIMENTS

Embodiments for implementing the present disclosure will be described below with reference to the drawings. Note, however, that dimensions and scales of portions in the drawings are made different from actual ones as appropriate. Furthermore, the embodiments described below are preferable specific examples of the present disclosure, and various technically preferable restrictions are therefore imposed on the embodiments, but the scope of the present disclosure is not limited to the embodiments unless there is a description that the present disclosure is particularly limited to the embodiments in the following description.

### 1: First Embodiment

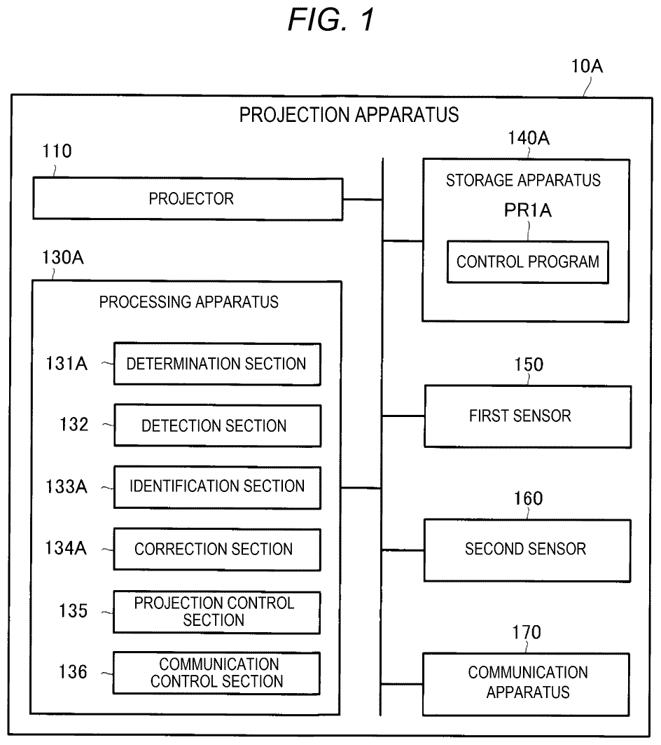

A projection apparatus 10A according to a first embodiment will be described below with reference to FIGS. 1 to 7.

### 1-1: Configuration of First Embodiment

FIG. 1 is a block diagram showing an example of the configuration of the projection apparatus 10A. The projection apparatus 10A includes a projector 110, a processing apparatus 130A, a storage apparatus 140A, a first sensor 150, a second sensor 160, and a communication apparatus 170. The elements of the projection apparatus 10A are coupled to each other via a single bus or multiple buses for information communication. The elements of the projection apparatus 10A may be configured with one or more instruments, and some elements of the projection apparatus 10A may be omitted.

The projector 110 is an apparatus that projects a projection image onto a projection receiving surface such as a wall or a screen. The projector 110 projects various projection images under the control of the processing apparatus 130A. The projector 110 includes, for example, an illuminator, a liquid crystal panel, and a projection lens system, and modulates light from the illuminator with the liquid crystal panel. The projector 110 projects the modulated light onto the projection receiving surface via the projection lens system.

The processing apparatus 130A is a processor that controls the entire projection apparatus 10A, and is configured, for example, with a single chip or multiple chips. The processing apparatus 130A is configured, for example, with a central processing unit (CPU) including an interface that interfaces the processing apparatus 130A with peripheral devices, an arithmetic apparatus, a register, and the like. Some or all of the functions of the processing apparatus 130A may be realized by hardware such as a digital signal processor (DSP), an application specific integrated circuit (ASIC), a programmable logic device (PLD), or a field programmable gate array (FPGA). The processing apparatus 130A performs various types of processing in parallel or in sequence.

The storage apparatus 140A is a recording medium readable by the processing apparatus 130A, and stores multiple programs including a control program PR1A to be executed by the processing apparatus 130A. The storage apparatus 140A may be configured, for example, with at least one of a read only memory (ROM), an erasable programmable ROM (EPROM), an electrically erasable programmable ROM (EEPROM), and a random access memory (RAM). The storage apparatus 140A may be called a register, a cache, a main memory, a main storage apparatus, or the like.

The first sensor 150 detects movement of the projection apparatus 10A. The first sensor 150 outputs the detected value to the processing apparatus 130A.

The first sensor 150 may, for example, be an acceleration sensor or a gyro sensor. The first sensor 150 may instead be an inertial measurement unit (IMU) including both an acceleration sensor and a gyro sensor.

When the first sensor 150 is an acceleration sensor, the first sensor 150 detects the movement of the projection apparatus 10A itself. When the first sensor 150 is a gyro sensor, the first sensor 150 detects the posture of the projection apparatus 10A in addition to the movement of the projection apparatus 10A itself.

The second sensor 160 detects the distance from the second sensor 160 to each of multiple positions on the projection receiving surface. The second sensor 160 outputs values indicating the distances to the storage apparatus 140A. The second sensor 160 is, for example, a time-of-flight (ToF) sensor.

The communication apparatus 170 is hardware serving as a transmitting and receiving device and used to communicate with other apparatuses. The communication apparatus 170 is also called, for example, a network device, a network controller, a network card, or a communication module. The communication apparatus 170 includes a connector for wired connection. Note that the communication apparatus 170 may include an interface for wireless communication. Examples of the interface for wireless communication may include interfaces compliant with wireless LAN and Bluetooth. “Bluetooth” is a registered trademark.

The processing apparatus 130A functions as a determination section 131A, a detection section 132, an identification section 133A, a correction section 134A, a projection control section 135, and a communication control section 136 by reading and executing the control program PR1A from the storage apparatus 140A. Note that the control program PR1A may be transmitted from another apparatus such as a server that manages the projection apparatus 10A via a communication network.

The determination section 131A determines whether the movement of the projection apparatus 10A has stopped based on the output from the first sensor 150. Specifically, the determination section 131A calculates a parameter value indicating the movement of the projection apparatus 10A based on the output from the first sensor 150. When a state in which the parameter value is smaller than a predetermined threshold continues for a predetermined period, the determination section 131A determines that the movement of the projection apparatus 10A has stopped. Note that the predetermined threshold is an example of a “first threshold”. Further note that the predetermined period is an example of a “first period”. In the present embodiment, the predetermined threshold and the predetermined period are fixed values, and may instead be values that can be changed by a user.

When the first sensor 150 is an acceleration sensor, the parameter value described above is, for example, an acceleration value. When the first sensor 150 is a gyro sensor, the parameter value described above is, for example, an angular acceleration value. The parameter value described above may be an average or a median of the acceleration values or the angular acceleration values measured over the predetermined period.

The detection section 132 detects at least one depth map indicating the distance from the second sensor 160 to each of multiple positions on the projection receiving surface during at least a predetermined period contained in the first period described above. Note that the predetermined period is an example of a “second period”. The “second period” is a portion of the “first period”. That is, the detection section 132 detects at least one depth map in the second period, which is a portion of the first period.

The detection section 132 may start the detection of the at least one depth map at a first point in time when it is determined that the parameter value indicating the movement of the projection apparatus 10A is smaller than the predetermined threshold. Note, however, that the detection section 132 may start the detection of the at least one depth map described above at another point in time. That is, the detection section 132 may detect at least one depth map in the entire first period. That is, the detection section 132 may detect at least one depth map in at least a portion of the first period.

The identification section 133A identifies the orientation of the projection apparatus 10A with respect to the projection receiving surface based on the at least one depth map detected by the detection section 132.

Note that only when the determination section 131A determines that the movement of the projection apparatus 10A has stopped, the identification section 133A may identify the orientation of the projection apparatus 10A with respect to the projection receiving surface based on at least one depth map detected by the detection section 132 by the point in time when the determination is made.

Instead, until the determination section 131A determines that the movement of the projection apparatus 10A has stopped, the identification section 133A may keep identifying the orientation of the projection apparatus 10A with respect to the projection receiving surface based on at least one depth map having been detected by the detection section 132.

When the determination section 131A determines that the movement of the projection apparatus 10A has stopped, the correction section 134A corrects distortion of an image projected by the projector 110 based on the orientation identified by the identification section 133A. As an example, the correction section 134A geometrically corrects an image to be projected onto the projection receiving surface based on the orientation identified by the identification section 133A in such a way that a display image to be displayed on the projection receiving surface by the projector 110 projecting the image onto the projection receiving surface has a rectangular shape.

Note that the correction section 134A may calculate a correction value used to correct the distortion of the image in the second period described above. The correction section 134A may instead calculate the aforementioned correction value used to correct the distortion of the image in a period other than the second period described above.

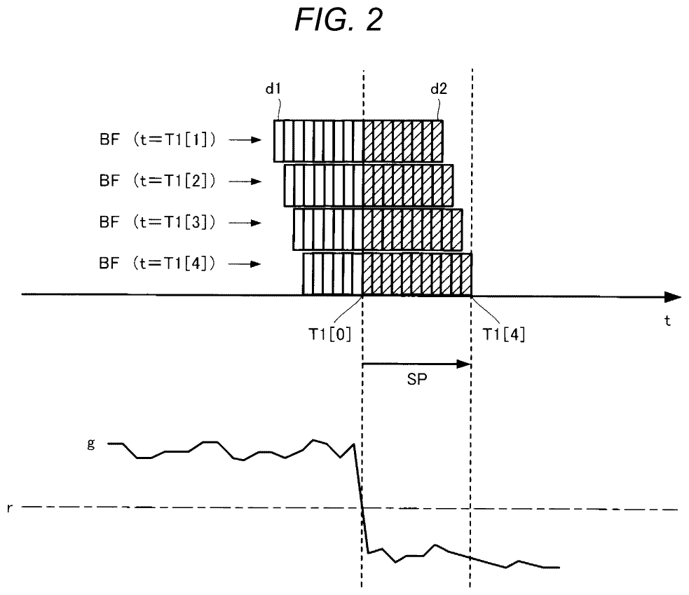

FIGS. 2 to 6 illustrates examples of the operations of the determination section 131A, the detection section 132, the identification section 133A, and the correction section 134A.

In FIG. 2, a set of rectangles located above the temporal axis indicating time t diagrammatically shows the state of a buffer BF at each point in time. Note that the buffer BF is a first-in-first-out buffer, for example, a ring buffer. The buffer BF is incorporated in the storage apparatus 140A. The buffer BF is an example of a “memory”. The buffer BF can freely update or change data stored therein based on an instruction from the processing apparatus 130A.

The set of rectangles located in the uppermost row indicates the state of data d1 and data d2 stored in the buffer BF at t=T1[1]. The data d1 and the data d2 will be described later in detail.

A set of rectangles located in a second row indicates the state of the data d1 and the data d2 stored in the buffer BF at t=T1[2].

A set of rectangles located in a third row indicates the state of the data d1 and the data d2 stored in the buffer BF at t=T1[3].

A set of rectangles located in a lowermost row indicates the state of the data d1 and the data d2 stored in the buffer BF at t=T1[4].

The polygonal line located below the temporal axis indicating the time t indicates a temporal change in acceleration g sensed by the first sensor 150.

It is assumed that the acceleration g becomes smaller than a threshold r at time t=T1[0], and that the state in which the acceleration g is smaller than the threshold r continues afterwards, as shown in FIG. 2. The determination section 131A starts stop determination of determining whether the movement of the projection apparatus 10A has stopped at the time t=T1[0]. Thereafter, the state in which the acceleration g is smaller than the threshold r has continued from the time t=T1[0] to the time t=T1[4] after a stop determination period SP, so that the determination section 131A determines that the movement of the projection apparatus 10A has stopped at the time t=T1[4].

At the time t=T[1] after the time t=T[0], the buffer BF stores data d1 corresponding to nine frames and data d2 corresponding to eight frames. The data d1 corresponding to nine frames are each data containing the depth map detected by the detection section 132 and stored in the buffer BF during a period for which the acceleration g is greater than or equal to the threshold r. In the example shown in FIG. 2, the data d1 is data containing the depth map stored in the buffer BF before the time t=T1[0]. The data d1 is an example of “first data based on the output from the second sensor before the first period”.

The data d2 corresponding to eight frames are each data containing the depth map detected by the detection section 132 and stored in the buffer BF during a period for which the acceleration g is smaller than the threshold r. In the example shown in FIG. 2, the data d2 is data containing the depth map stored in the buffer BF after the time t=T1[0]. The data d2 is an example of “second data based on the output from the second sensor in at least a portion of the first period”.

In the present embodiment, data containing a depth map is stored in the buffer BF in real time. Therefore, at the time t=T1[0], the data d1 acquired when the projection apparatus 10A is moving may have already been stored. Therefore, in the present embodiment, when the data d1 based on the output from the second sensor 160 before the first period is stored in the buffer BF at the time t=T1[0], the processing apparatus 130A causes the buffer BF to sequentially update the data d1 to the data d2 based on the output from the second sensor in at least a portion of the first period.

At the time t=T1[2] after the time t=T1[1], the buffer BF stores data d1 corresponding to eight frames and data d2 corresponding to nine frames.

At the time t=T1[3] after the time t=T1[2], the buffer BF stores data d1 corresponding to seven frames and data d2 corresponding to ten frames.

At the time t=T1[4] after the time t=T1[3], the buffer BF stores data d1 corresponding to six frames and data d2 corresponding to eleven frames.

That is, the data d1 is sequentially updated to the data d2 after the time t=T1[0], and is replaced at the time t=T1[4] with the data d2 based on the output from the second sensor in the first period.

Note that the aforementioned numbers of frames in the data d1 and the data d2 stored in the buffer BF are merely examples in the diagrammatic description. The same applies to the following figures. Furthermore, when data containing a depth map is not stored in the buffer BF in real time, for example, in a case where the buffer BF starts to store the data at the time t=T1[0], at the first point in time when the acceleration g becomes smaller than the threshold r, the update described above may not be performed.

The identification section 133A identifies the orientation of the projection apparatus 10A with respect to the projection receiving surface based on the depth map contained in the data d2 corresponding to eleven frames at time t=T1[4].

Note that the identification section 133A may identify the orientation of the projection apparatus 10A with respect to the projection receiving surface based on the depth map contained in the data d2 stored in the buffer BF by the point in time when the identification is made at each point in time from the time t=T1[1] to the time t=T1[3].

Specifically, the identification section 133A may identify the orientation of the projection apparatus 10A with respect to the projection receiving surface based on the depth map contained in the data d2 corresponding to eight frames at the time t=T1[1].

The identification section 133A may instead identify the orientation of the projection apparatus 10A with respect to the projection receiving surface based on the depth map contained in the data d2 corresponding to nine frames at the time t=T1[2].

The identification section 133A may still instead identify the orientation of the projection apparatus 10A with respect to the projection receiving surface based on the depth map contained in the data d2 corresponding to ten frames at the time t=T1[3].

The correction section 134A starts calculation for correcting the distortion of the image projected by the projector 110 based on the orientation identified by the identification section 133A at the time t=T1[4].

In FIG. 2, the first period described above corresponds to the stop determination period SP. The second period described above also corresponds to the stop determination period SP. The first threshold described above corresponds to the threshold r.

In FIG. 2, the detection section 132 may start the detection of the depth map at the time t=T1[0]. The time t=T1[0] is the first point in time when it is determined that the acceleration g is smaller than the threshold r.

Furthermore, in FIG. 2, the correction section 134A may calculate the correction value used to correct the distortion of the image projected from the projector 110 in the stop determination period SP, which is also the second period.

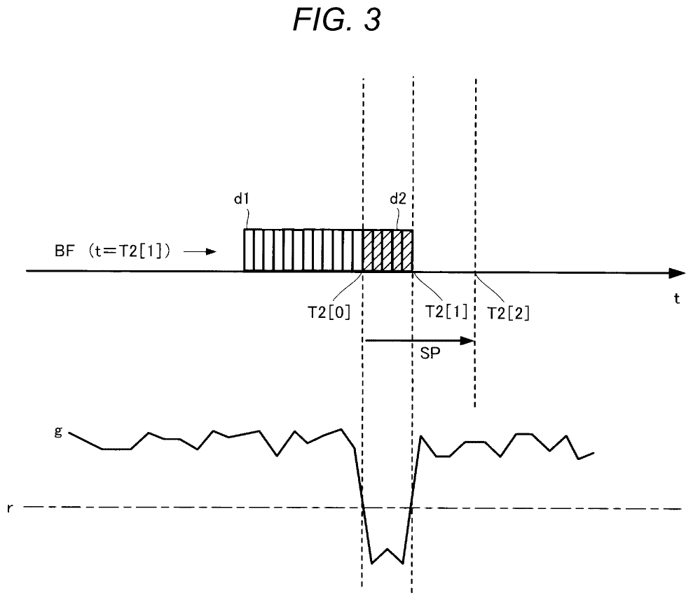

FIG. 3 shows a case where the projection apparatus 10A has moved during the stop determination period SP. It is assumed that the acceleration g becomes smaller than the threshold r at time t=T2[0], as shown in FIG. 3. It is further assumed in FIG. 3 that the time after the stop determination period SP has elapsed from the time t=T2[0] is time t=T2[2].

It is assumed that the acceleration g becomes greater than or equal to the threshold r again at time t=T2[1], as shown in FIG. 3. At this point in time, the buffer BF stores data d1 corresponding to twelve frames and data d2 corresponding to five frames. In this case, the identification section 133A does not identify the orientation of the projection apparatus 10A with respect to the projection receiving surface based on the data d2 corresponding to five frames. As a result, the correction section 134A does not correct the distortion of the image projected by the projector 110 until it is determined that the movement of the projection apparatus 10A has stopped at a point in time after the time t=T2[1].

Note in FIG. 3 that the data d1 or the data d2 keeps being stored in the buffer BF at a point in time after the time t=T2[1].

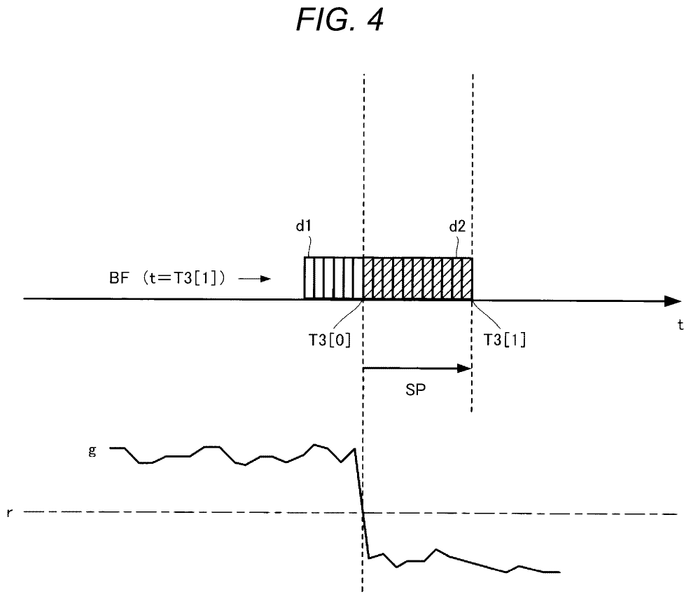

FIG. 4 shows a case where all the data d2 stored in the buffer BF during the stop determination period SP is used as data for correction.

It is assumed that the acceleration g becomes smaller than the threshold r at time t=T3[0], as shown in FIG. 4. In FIG. 4, it is assumed that the time after the stop determination period SP has elapsed from the time t=T3[0] is time t=T3[1].

The state in which the acceleration g is smaller than the threshold r is maintained throughout the stop determination period SP, so that the determination section 131A determines that the projection apparatus 10A has stopped at the time t=T3[1], as shown in FIG. 4.

The identification section 133A identifies the orientation of the projection apparatus 10A with respect to the projection receiving surface based on the depth map indicated by the data d2 corresponding to eleven frames at the time t=T3[1] by way of example.

The correction section 134A starts calculation for correcting the distortion of the image projected by the projector 110 based on the orientation identified by the identification section 133A at the time t=T3[1].

In FIG. 4, the first period described above corresponds to the stop determination period SP. The second period described above also corresponds to the stop determination period SP. The first threshold described above corresponds to the threshold r.

In FIG. 4, the detection section 132 may start the detection of the depth map at the time t=T3[0]. The time t=T3[0] is the first point in time when it is determined that the acceleration g is smaller than the threshold r.

Furthermore, in FIG. 4, the correction section 134A may calculate the correction value used to correct the distortion of the image projected from the projector 110 in the stop determination period SP, which is also the second period.

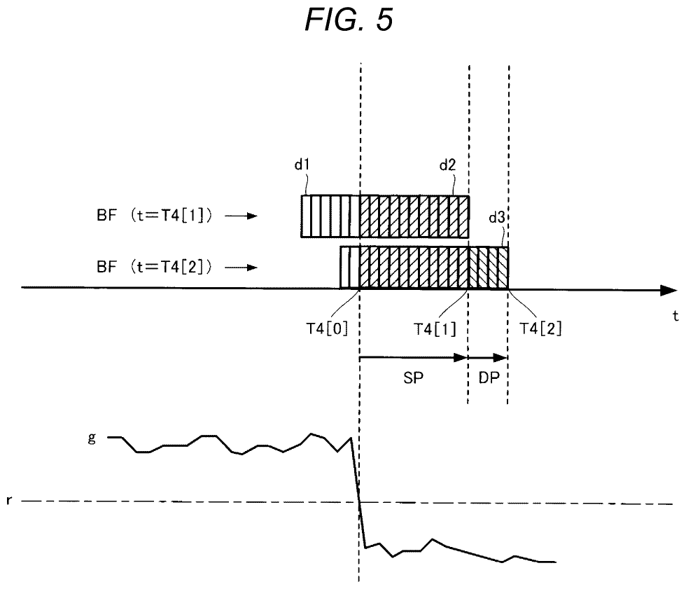

FIG. 5 shows a case where all the data d2 stored in the buffer BF during the stop determination period SP and data d3 is used as the data for correction. The data d3 will be described later in detail.

It is assumed that the acceleration g becomes smaller than the threshold r at time t=T4[0], as shown in FIG. 5. It is further assumed in FIG. 5 that the time after the stop determination period SP has elapsed from the time t=T4[0] is time t=T4[1].

The state in which the acceleration g is smaller than the threshold r is maintained throughout the stop determination period SP, so that the determination section 131A determines that the movement of the projection apparatus 10A has stopped at the time t=T4[1], as shown in FIG. 5.

As an example, it is assumed that the identification section 133A has attempted to identify the orientation of the projection apparatus 10A with respect to the projection receiving surface based on the depth map indicated by the data d2 corresponding to eleven frames at the time t=T4[1], but that the orientation of the projection apparatus 10A has not been successfully identified because the data d2 corresponding to eleven frames are not sufficient to achieve desired accuracy.

In this case, as an example, the identification section 133A identifies the orientation of the projection apparatus 10A with respect to the projection receiving surface based on data d3 corresponding to four frames and stored in the buffer BF in an additional period DP from the time t=T4[1] to time t=T4[2] in addition to the data d2 corresponding to eleven frames. Note that it is assumed that the state in which the acceleration g is smaller than the threshold r is maintained from the time t=T4[1] to the time t=T4[2].

The data d3 corresponding to four frames are each data containing the depth map detected by the detection section 132 and stored in the buffer BF in the additional period DP after the point in time when the acceleration g is smaller than the threshold r and the movement of the projection apparatus 10A is determined to have stopped.

Note that the criterion for determining whether the “accuracy” described above is sufficient or insufficient is, as an example, a criterion regarding whether the identification section 133A can identify the orientation of the projection apparatus 10A with respect to the projection receiving surface based on the depth map contained in the data d2 containing frames the number of which is greater than or equal to a number set in advance. The “number of frames set in advance” may be specified based on the accuracy of the second sensor 160 itself by way of example. The “number of frames set in advance” may instead be a function of the distance from the second sensor 160 to the projection receiving surface by way of example. The “number of frames set in advance” may still instead be specified in accordance with whether the distance from the second sensor 160 to the projection receiving surface exceeds a threshold by way of example.

The “accuracy” described above may instead be determined based on the accuracy of the depth map itself contained in the data d2 corresponding to eleven frames and stored in the buffer BF.

The same applies to “accuracy” described in the following examples.

At the time t=T4[2], the correction section 134A starts the calculation for correcting the distortion of the image projected by the projector 110 based on the orientation identified by the identification section 133A.

In FIG. 5, the first period described above corresponds to the stop determination period SP. The second period described above also corresponds to the stop determination period SP. The first threshold described above corresponds to the threshold r.

In FIG. 5, the detection section 132 may start the detection of the depth map at the time t=T4[0]. The time t=T4[0] is the first point in time when it is determined that the acceleration g is smaller than the threshold r.

Furthermore, in FIG. 5, the correction section 134A may calculate the correction value used to correct the distortion of the image projected from the projector 110 in the stop determination period SP, which is also the second period.

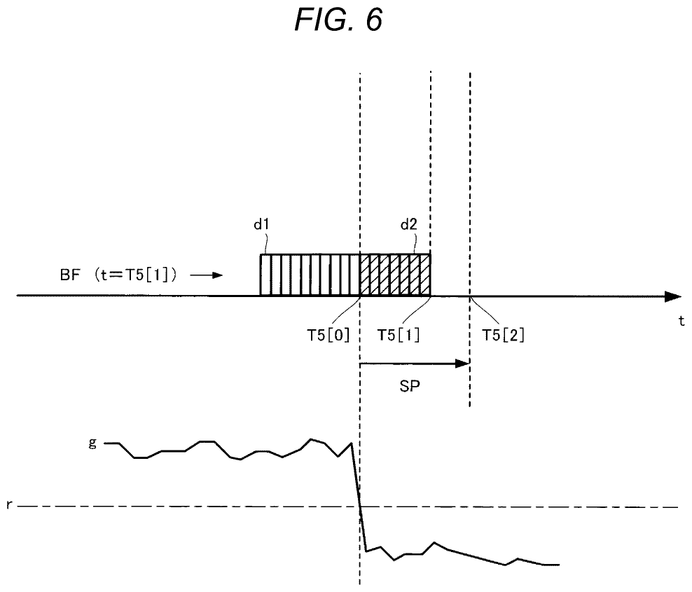

FIG. 6 shows a case where only a portion of the data d2 stored in the buffer BF during the stop determination period SP is used as the data for correction.

It is assumed that the acceleration g becomes smaller than the threshold r at time t=T5[0], as shown in FIG. 6. It is further assumed in FIG. 6 that the time after the stop determination period SP has elapsed from the time t=T5[0] is time t=T5[1].

It is assumed that at the point in the time t=T5[1] between the time t=T5[0] and time t=T5[2], the buffer BF stores data d1 corresponding to ten frames and data d2 corresponding to seven frames, as shown in FIG. 6. It is further assumed that at the time t=T5[2], the buffer BF stores the data d1 corresponding to six frames and the data d2 corresponding to eleven frames, as at the time t=T3[1] in FIG. 4. That is, at the time t=T5[1] in FIG. 6, only a portion of the data d2 is stored out of the data d2 corresponding to eleven frames to be stored in the buffer BF at the time t=T5[2], at which it is determined that the projection apparatus 10A is stationary.

However, when the data d2 corresponding to seven frames stored in the buffer BF has sufficiently high accuracy at the time t=T5[1], the identification section 133A identifies the orientation of the projection apparatus 10A based on the depth map contained in the data d2 corresponding to seven frames at the time t=T5[1].

The correction section 134A starts the calculation for correcting the distortion of the image projected by the projector 110 based on the orientation identified by the identification section 133A at the time t=T5[1]. It is preferable that the correction section 134A has completed the correction at the time t=T5[2] as a result of the calculation. In this case, the correction performed by the correction section 134A has already been completed at the point in time when the determination section 131A determines that the movement of the projection apparatus 10A has stopped.

In FIG. 6, the first period described above corresponds to the stop determination period SP. The second period described above corresponds to the period from the time t=T5[0] to the time t=T5[1]. The first threshold described above corresponds to the threshold r.

In FIG. 6, the detection section 132 may start the detection of the depth map at the time t=T5[0]. The time t=T5[0] is the first point in time when it is determined that the acceleration g is smaller than the threshold r.

Furthermore, in FIG. 6, the correction section 134A may calculate the correction value used to correct the distortion of the image projected from the projector 110 in the period from the time t=T5[0] to the time t=T5[1], which is the second period.

In FIG. 1, the projection control section 135 causes the projector 110 to project the image corrected by the correction section 134A onto the projection receiving surface.

The communication control section 136 causes the communication apparatus 170 to transmit and receive various data to and from apparatuses outside the projection apparatus 10A.

### 1-2: Operation in First Embodiment

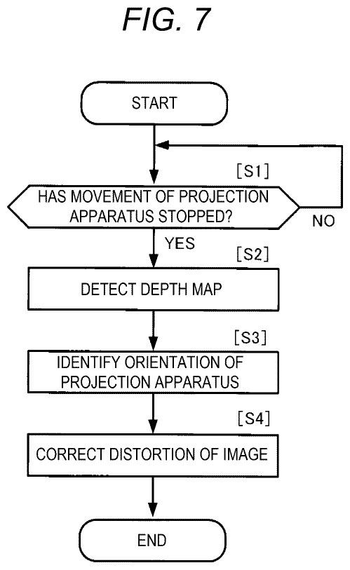

FIG. 7 is a flowchart showing an example of the operation of the projection apparatus 10A.

In step S1, the processing apparatus 130A functions as the determination section 131A. The processing apparatus 130A determines whether the movement of the projection apparatus 10A has stopped based on the output from the first sensor 150. Specifically, the processing apparatus 130A calculates the parameter value indicating the movement of the projection apparatus 10A based on the output from the first sensor 150. When the state in which the parameter value is smaller than the predetermined threshold continues for the first period, the processing apparatus 130A determines that the movement of the projection apparatus 10A has stopped. When the processing apparatus 130A determines that the movement of the projection apparatus 10A has stopped (YES in step S1), the processing apparatus 130A performs the operation in step S2. On the other hand, when the processing apparatus 130A does not determine that the movement of the projection apparatus 10A has stopped (NO in step S1), the processing apparatus 130A performs the operation in step S1.

In step S2, the processing apparatus 130A functions as the detection section 132. The processing apparatus 130A detects at least one depth map indicating the distance from the second sensor 160 to each of the multiple positions on the projection receiving surface in at least the second period.

In step S3, the processing apparatus 130A functions as the identification section 133A. The processing apparatus 130A identifies the orientation of the projection apparatus 10A with respect to the projection receiving surface based on the at least one depth map detected in step S2.

In step S4, the processing apparatus 130A functions as the correction section 134A. The processing apparatus 130A corrects distortion of the image projected by the projector 110 based on the orientation identified in step S3.

### 2: Second Embodiment

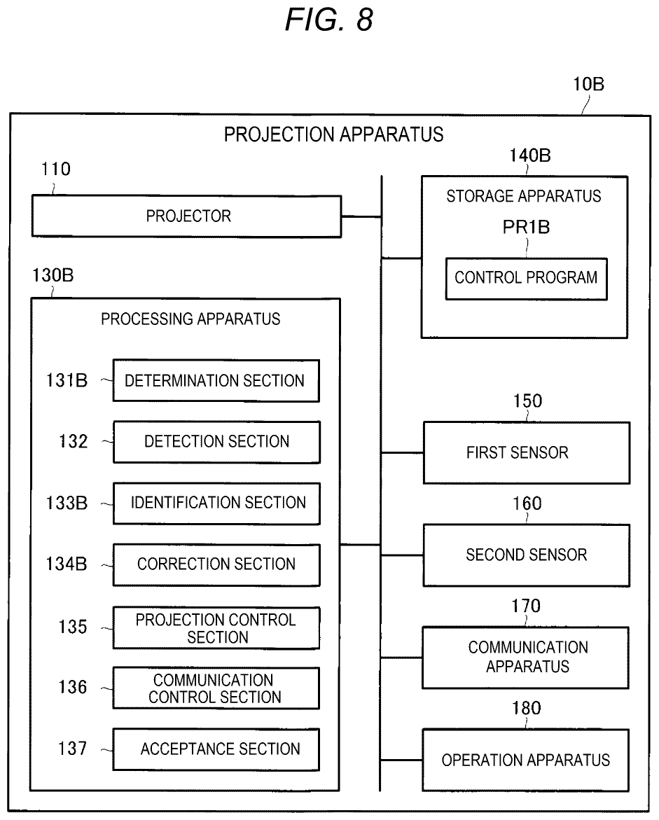

A projection apparatus 10B according to a second embodiment will be described below with reference to FIGS. 8 to 11. The following description will be primarily made about differences of the projection apparatus 10B according to the present embodiment from the projection apparatus 10A according to the first embodiment for simplification of the description. In the following description, out of the elements provided in the projection apparatus 10B according to the present embodiment, elements that are the same as those provided in the projection apparatus 10A according to the first embodiment have the same reference characters, and the functions of the same elements may not be described.

In the projection apparatus 10A according to the first embodiment, an image projected by the projector 110 is corrected in response to the fact that it is determined that the movement of the projection apparatus 10A has stopped. On the other hand, in the projection apparatus 10B according to the present embodiment, the image projected by the projector 110 is corrected in response to the fact that the user operates an operation apparatus 180, which is provided in the projection apparatus 10B and will be described later.

### 2-1: Configuration in Second Embodiment

FIG. 8 is a block diagram showing an example of the configuration of the projection apparatus 10B. As compared with the projection apparatus 10A, the projection apparatus 10B includes a processing apparatus 130B in place of the processing apparatus 130A and a storage apparatus 140B in place of the storage apparatus 140A. The projection apparatus 10B further includes the operation apparatus 180 in addition to the projector 110, the processing apparatus 130B, the storage apparatus 140B, the first sensor 150, the second sensor 160, and the communication apparatus 170.

The storage apparatus 140B stores a control program PR1B in place of the control program PR1A stored in the storage apparatus 140A.

The operation apparatus 180 is an apparatus used by the user of the projection apparatus 10B to operate the projection apparatus 10B. The operation apparatus 180 is, for example, a remote control that transmits and receives signals by wirelessly communicating with the processing apparatus 130B. An instruction corresponding to an operation performed by the user via the operation apparatus 180 is input to the processing apparatus 130B.

In the present embodiment, the operation apparatus 180 inputs an instruction indicating image distortion correction to the processing apparatus 130B based on the user's operation.

Note that the operation apparatus 180 is an example of an “operation device”.

The processing apparatus 130B functions as a determination section 131B, the detection section 132, an identification section 133B, a correction section 134B, the projection control section 135, the communication control section 136, and an receiving section 137 by reading and executing the control program PR1B from the storage apparatus 140B. Note that the control program PR1B may be transmitted from another apparatus such as a server that manages the projection apparatus 10B via a communication network.

The receiving section 137 receives an instruction indicating image distortion correction via the operation apparatus 180.

The determination section 131B determines whether the movement of the projection apparatus 10B has stopped, as the determination section 131A. The determination section 131B further determines whether the receiving section 137 has received the instruction indicating image distortion correction via the operation apparatus 180.

The identification section 133B may identify the orientation of the projection apparatus 10B with respect to the projection receiving surface only after the determination section 131B determines that the movement of the projection apparatus 10B has stopped and the determination section 131B determines that the receiving section 137 has received the instruction indicating image distortion correction, the identification being made based on at least one depth map detected by the detection section 132 by the point in time when the determination is made.

Instead, the identification section 133B may keep identifying the orientation of the projection apparatus 10B with respect to the projection receiving surface until the determination section 131B determines that the movement of the projection apparatus 10B has stopped and the determination section 131B determines that the receiving section 137 has received the instruction indicating image distortion correction, the identification being made based on at least one depth map detected by the detection section 132.

When the determination section 131B determines that the movement of the projection apparatus 10B has stopped and the determination section 131B determines that the receiving section 137 has received the instruction indicating image distortion correction, the correction section 134B corrects the distortion of the image projected by the projector 110 based on the orientation identified by the identification section 133B.

Note that the timing at which the correction section 134B corrects the distortion of the image may be synchronized with the timing at which the receiving section 137 receives the instruction indicating image distortion correction.

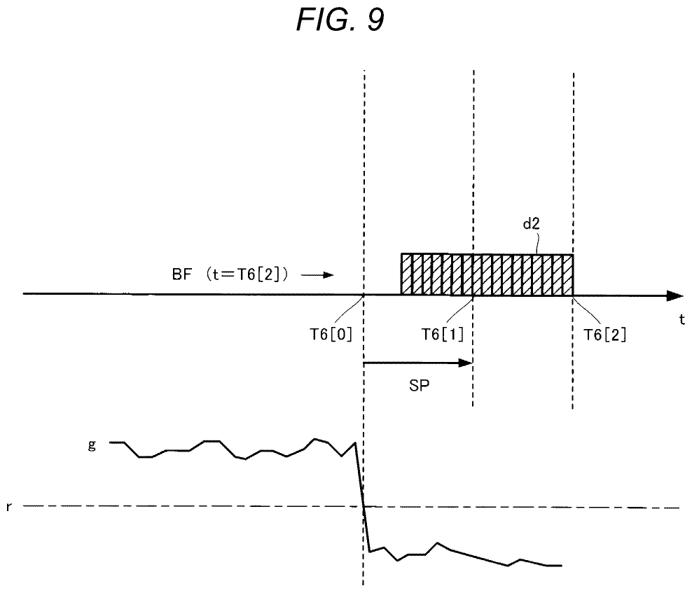

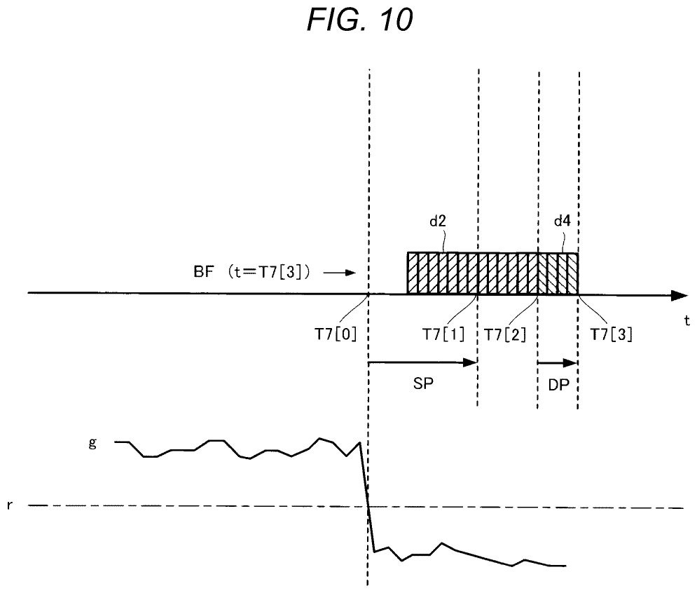

FIGS. 9 and 10 illustrate examples of the operations of the determination section 131B, the detection section 132, the identification section 133B, and the correction section 134B.

It is assumed that the acceleration g becomes smaller than the threshold r at time t=T6[0], as shown in FIG. 9. It is further assumed in FIG. 9 that the time after the stop determination period SP has elapsed from the time t=T6[0] is time t=T6[1].

It is now assumed that the receiving section 137 has received the instruction indicating image distortion correction from the operation apparatus 180 at time t=T6[2]. Note that it is assumed that the state in which the acceleration g is smaller than the threshold r is maintained from the time t=T6[1] to the time t=T6[2].

The identification section 133B identifies the orientation of the projection apparatus 10B with respect to the projection receiving surface based on the depth map indicated by all the data d2 corresponding to seventeen frames stored in the buffer BF at the time t=T6[2].

The correction section 134B starts the calculation for correcting the distortion of the image projected by the projector 110 based on the orientation identified by the identification section 133B at the time t=T6[2].

Note that the time t=T6[2] at which the correction section 134B starts the calculation for correcting the distortion of the image projected by the projector 110 is equal to the time t=T6[2] at which the receiving section 137 receives the instruction indicating image distortion correction from the operation apparatus 180.

FIG. 10 shows a case where all the data d2 stored in the buffer BF at the point in time when the receiving section 137 receives the instruction indicating image distortion correction from the operation apparatus 180 and data d4 are used as the data for correction. The data d4 will be described later in detail.

It is assumed that the acceleration g becomes smaller than the threshold r at time t=T7[0], as shown in FIG. 10. It is further assumed in FIG. 10 that the time after the stop determination period SP has elapsed from the time t=T7[0] is time t=T7[1].

It is now assumed that the receiving section 137 has received the instruction indicating image distortion correction from the operation apparatus 180 at time t=T7[2]. Note that it is assumed that the state in which the acceleration g is smaller than the threshold r is maintained from the time t=T7[1] to the time t=T7[2].

It is assumed that the identification section 133B has attempted to identify the orientation of the projection apparatus 10B with respect to the projection receiving surface based on the depth map contained in all the data d2 corresponding to eleven frames stored in the buffer BF at the time t=T7[2], but that the orientation of the projection apparatus 10B has not been successfully identified because the data d2 corresponding to thirteen frames are not sufficient to achieve desired accuracy.

In this case, as an example, the identification section 133B identifies the orientation of the projection apparatus 10B with respect to the projection receiving surface based on data d4 corresponding to four frames and stored in the buffer BF in an additional period DP from the time t=T7[2] to time t=T7[3] in addition to the data d2 corresponding to thirteen frames.

The data d4 corresponding to four frames are each data containing the depth map detected by the detection section 132 and stored in the buffer BF in the additional period DP after the point in time when the acceleration g is smaller than the threshold r and the receiving section 137 receives the instruction indicating image distortion correction from the operation apparatus 180.

The correction section 134B starts the calculation for correcting the distortion of the image projected by the projector 110 based on the orientation identified by the identification section 133B at the time t=T7[3].

### 2-2. Operation in Second Embodiment

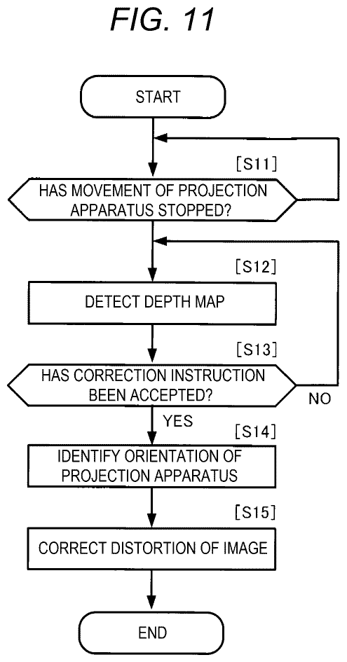

FIG. 11 is a flowchart showing an example of the operation of the projection apparatus 10B.

In step S11, the processing apparatus 130B functions as the determination section 131B. The processing apparatus 130B determines whether the movement of the projection apparatus 10B has stopped based on the output from the first sensor 150. Specifically, the processing apparatus 130B determines that the movement of the projection apparatus 10B has stopped when a state in which a parameter value indicating the movement of the projection apparatus 10B is smaller than a predetermined threshold continues for the first period based on the output from the first sensor 150. When the processing apparatus 130B determines that the movement of the projection apparatus 10B has stopped (YES in step S11), the processing apparatus 130B performs the operation in step S12. On the other hand, when the processing apparatus 130B does not determine that the movement of the projection apparatus 10B has stopped (NO in step S11), the processing apparatus 130B performs the operation in step S11.

In step S12, the processing apparatus 130B functions as the detection section 132. The processing apparatus 130B detects at least one depth map indicating the distance from the second sensor 160 to each of the multiple positions on the projection receiving surface.

In step S13, the processing apparatus 130B functions as the determination section 131B. The processing apparatus 130B determines whether the receiving section 137 has received the instruction indicating image distortion correction via the operation apparatus 180. When the processing apparatus 130B determines that the receiving section 137 has received the instruction indicating image distortion correction (YES in step S13), the processing apparatus 130B performs the operation in step S14. On the other hand, when the processing apparatus 130B does not determine that the receiving section 137 has received the instruction indicating image distortion correction (NO in step S13), the processing apparatus 130B performs the operation in step S12.

In step S14, the processing apparatus 130B functions as the identification section 133B. The processing apparatus 130B identifies the orientation of the projection apparatus 10B with respect to the projection receiving surface based on the at least one depth map detected in step S12.

In step S15, the processing apparatus 130B functions as the correction section 134B. The processing apparatus 130B corrects the distortion of the image projected by the projector 110 based on the orientation identified in step S14.

### 3: Third Embodiment

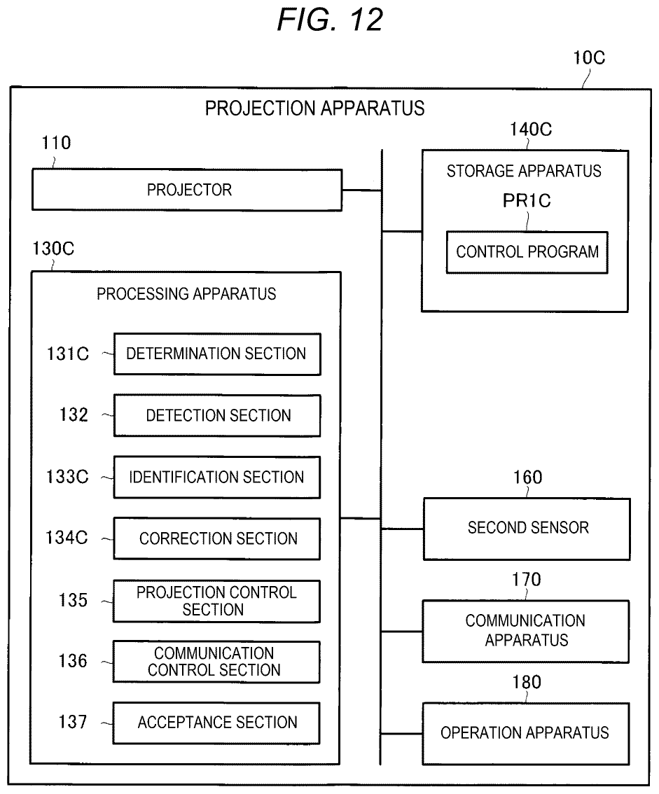

A projection apparatus 10C according to a third embodiment will be described below with reference to FIGS. 12 to 15. The following description will be primarily made about differences of the projection apparatus 10C according to the present embodiment from the projection apparatus 10A according to the first embodiment and the projection apparatus 10B according to the second embodiment for simplification of the description. In the following description, out of the elements provided in the projection apparatus 10C according to the present embodiment, elements that are the same as those provided in the projection apparatus 10A according to the first embodiment and the projection apparatus 10B according to the second embodiment have the same reference characters, and the functions of the same elements may not be described.

The projection apparatus 10A according to the first embodiment and the projection apparatus 10B according to the second embodiment include two sensors, the first sensor 150, which detects movement of the projection apparatus 10A, and the second sensor 160, which detects the distance from the second sensor 160 to each of the multiple positions on the projection receiving surface. In contrast, the projection apparatus 10C according to the present embodiment does not include the first sensor 150 and therefore does not determine whether the movement of the projection apparatus 10C has stopped, as will be described later.

### 3-1: Configuration in Third Embodiment

FIG. 12 is a block diagram showing an example of the configuration of the projection apparatus 10C. Compared with the projection apparatus 10B, the projection apparatus 10C includes a processing apparatus 130C in place of the processing apparatus 130B and a storage apparatus 140C in place of the storage apparatus 140B. The projection apparatus 10C further includes the projector 110, the processing apparatus 130C, the storage apparatus 140C, the second sensor 160, the communication apparatus 170, and the operation apparatus 180. That is, the projection apparatus 10C does not include the first sensor 150.

The storage apparatus 140C stores a control program PR1C in place of the control program PR1B stored in the storage apparatus 140B.

The processing apparatus 130C functions as a determination section 131C, the detection section 132, an identification section 133C, a correction section 134C, the projection control section 135, the communication control section 136, and the receiving section 137 by reading and executing the control program PR1C from the storage apparatus 140C. Note that the control program PR1B may be transmitted from another apparatus such as a server that manages the projection apparatus 10C via a communication network.

The determination section 131C determines whether the receiving section 137 has received the instruction indicating image distortion correction via the operation apparatus 180. Unlike the determination section 131A and the determination section 131B, the determination section 131C does not determine whether the movement of the projection apparatus 10C has stopped.

The identification section 133C may identify the orientation of the projection apparatus 10C with respect to the projection receiving surface only after the determination section 131C determines that the receiving section 137 has received the instruction indicating the image distortion correction, the identification being made based on at least one depth map detected by the detection section 132 by the point in time when the determination is made.

Instead, the identification section 133C may keep identifying the orientation of the projection apparatus 10C with respect to the projection receiving surface until the determination section 131C determines that the receiving section 137 has received the instruction indicating image distortion correction, the identification being made based on at least one depth map detected by the detection section 132.

When the determination section 131C determines that the receiving section 137 has received the instruction indicating image distortion correction, the correction section 134C corrects the distortion of the image projected by the projector 110 based on the orientation identified by the identification section 133C.

Note that the timing at which the correction section 134C corrects the distortion of the image may be synchronized with the timing at which the receiving section 137 receives the instruction indicating image distortion correction.

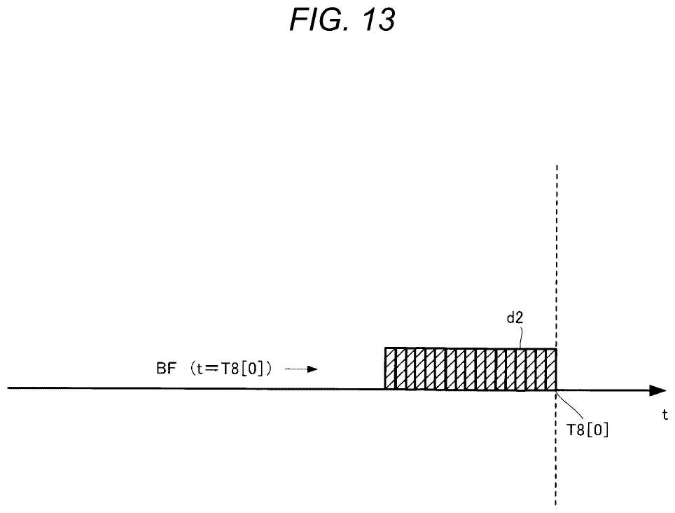

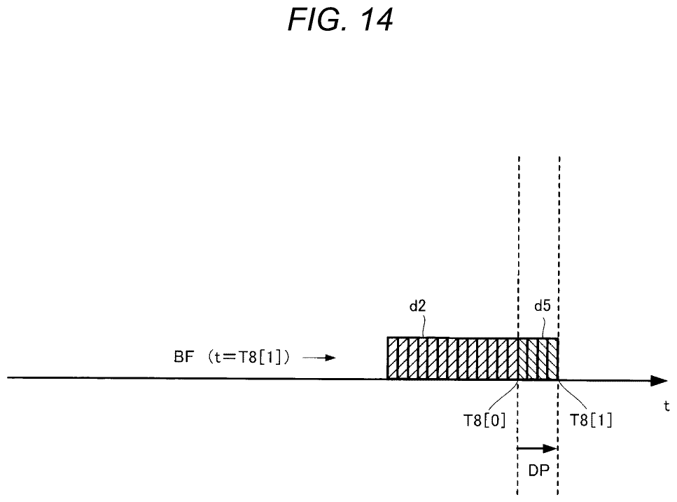

FIGS. 13 and 14 illustrating examples of the operations of the determination section 131C, the detection section 132, the identification section 133C, and the correction section 134C.

It is assumed that the receiving section 137 has received the instruction indicating image distortion correction from the operation apparatus 180 at time t=T8[0] in FIG. 13. Note that it is assumed that the user of the projection apparatus 10C expects that the movement of the projection apparatus 10C has stopped by the time t=T8[0].

The identification section 133C identifies the orientation of the projection apparatus 10C with respect to the projection receiving surface based on the depth map contained in all the data d2 corresponding to seventeen frames stored in the buffer BF at the time t=T8[0].

The correction section 134C starts the calculation for correcting the distortion of the image projected by the projector 110 based on the orientation identified by the identification section 133C at the time t=T8[0].

Note that the time t=T8[0] at which the correction section 134C starts the calculation for correcting the distortion of the image projected by the projector 110 is equal to the time t=T8[0] at which the receiving section 137 receives the instruction indicating image distortion correction from the operation apparatus 180.

FIG. 14 shows a case where all the data d2 stored in the buffer BF at the point in time when the receiving section 137 receives the instruction indicating image distortion correction from the operation apparatus 180 and data d5 are used as the data for correction. The data d5 will be described later in detail.

It is assumed that the receiving section 137 has received the instruction indicating image distortion correction from the operation apparatus 180 at the time t=T8[0] in FIG. 14. Note that it is assumed that the user of the projection apparatus 10C expects that the movement of the projection apparatus 10C has stopped by the time t=T8[0].

It is assumed that the identification section 133C has attempted to identify the orientation of the projection apparatus 10C with respect to the projection receiving surface based on the depth map contained in all the data d2 corresponding to eleven frames stored in the buffer BF at the time t=T8[0], but that the orientation of the projection apparatus 10C has not been successfully identified because the data d2 corresponding to thirteen frames are not sufficient to achieve desired accuracy.

In this case, as an example, the identification section 133C identifies the orientation of the projection apparatus 10C with respect to the projection receiving surface based on the depth map indicated by data d5 corresponding to four frames and stored in the buffer BF in the additional period DP from the time t=T8[0] to time t=T8[1] in addition to the data d2 corresponding to thirteen frames.

The data d5 corresponding to four frames are each data containing the depth map detected by the detection section 132 and stored in the buffer BF in the additional period DP after the point in time when the receiving section 137 receives the instruction indicating image distortion correction from the operation apparatus 180.

The correction section 134C starts the calculation for correcting the distortion of the image projected by the projector 110 based on the orientation identified by the identification section 133C at the time t=T8[1].

### 3-2. Operation in Third Embodiment

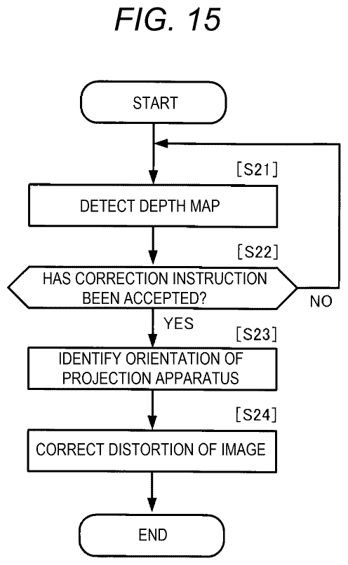

FIG. 15 is a flowchart showing an example of the operation of the projection apparatus 10C.

In step S21, the processing apparatus 130C functions as the detection section 132. The processing apparatus 130C detects at least one depth map indicating the distance from the second sensor 160 to each of the multiple positions on the projection receiving surface.

In step S22, the processing apparatus 130C functions as the determination section 131C. The processing apparatus 130C determines whether the receiving section 137 has received the instruction indicating image distortion correction via the operation apparatus 180. When the processing apparatus 130C determines that the receiving section 137 has received the instruction indicating image distortion correction (YES in step S22), the processing apparatus 130C performs the operation in step S23. On the other hand, when the processing apparatus 130C does not determine that the receiving section 137 has received the instruction indicating image distortion correction (NO in step S22), the processing apparatus 130C performs the operation in step S21.

In step S23, the processing apparatus 130C functions as the identification section 133C. The processing apparatus 130C identifies the orientation of the projection apparatus 10C with respect to the projection receiving surface based on the at least one depth map detected in step S21.

In step S24, the processing apparatus 130C functions as the correction section 134C. The processing apparatus 130C corrects the distortion of the image projected by the projector 110 based on the orientation identified in step S23.

### 4: Variations

The embodiments described above can be changed in various manners. Specific aspects of the variations will be presented below by way of example. The aspects presented below by way of example and the aspects shown in the embodiments described above can be combined with each other as appropriate to the extent that the aspects to be combined with each other do not contradict each other. Note that in the variations presented below by way of example, elements providing effects and having functions that are the same as those in the embodiments have the same reference characters referred to in the above description, and will not be described in detail as appropriate.

### 4-1: Variation 1

In the projection apparatus 10A according to the first embodiment, the determination section 131A, the detection section 132, the identification section 133A, and the correction section 134A are provided in the processing apparatus 130A. Note, however, that the determination section 131A, the detection section 132, the identification section 133A, and the correction section 134A may be provided in an external apparatus separate from the projection apparatus 10A. As an example, the determination section 131A, the detection section 132, the identification section 133A, and the correction section 134A may be provided in a control apparatus that controls the projection apparatus 10A. In this case, the control apparatus receives the output from the first sensor 150 and the output from the second sensor 160 provided in the projection apparatus 10A via a communication network. Furthermore, the control apparatus transmits the output from the correction section 134A to the projection apparatus 10A via the communication network.

The same applies to the projection apparatus 10B according to the second embodiment and the projection apparatus 10C according to the third embodiment.

### 4-2: Variation 2

In the projection apparatus 10A according to the first embodiment, the identification section 133A identifies the orientation of the projection apparatus 10A with respect to the projection receiving surface based on at least one depth map detected by the detection section 132.

The identification section 133A may identify only one orientation of the projection apparatus 10A with respect to the projection receiving surface based on the at least one depth map detected by the detection section 132.

Instead, the at least one depth map detected by the detection section 132 and the orientation of the projection apparatus 10A identified by the identification section 133A may correspond to each other in a one-to-one relationship. In this case, the identification section 133A specifies one orientation based on the one depth map. The number of depth maps detected by the detection section 132 and the number of orientations of the projection apparatus 10A identified by the identification section 133A are equal to each other.

When the identification section 133A identifies multiple orientations of the projection apparatus 10A with respect to the projection receiving surface, the correction section 134A corrects the distortion of the image projected by the projector 110 based on the multiple orientations identified by the identification section 133A.

The same applies to the projection apparatus 10B according to the second embodiment and the projection apparatus 10C according to the third embodiment.

### 4-3: Variation 3

In the projection apparatus 10A according to the first embodiment, the correction section 134A corrects the distortion of the image projected by the projector 110 based on the orientation identified by the identification section 133A. The correction section 134A may instead calculate a gravity vector based on the output from the first sensor 150, and correct the distortion of the image projected by the projector 110 based on the gravity vector.

In this case, the data d1 and the data d2 shown in FIG. 2 contain the gravity vector described above by way of example.

Instead, the correction section 134A may correct the distortion of the image projected by the projector 110 based on both the orientation identified by the identification section 133A and the gravity vector described above.

In this case, the data d1 and the data d2 shown in FIG. 2 contain the depth map described above and the gravity vector described above by way of example.

The same applies to the projection apparatus 10B according to the second embodiment.

### 4-4: Variation 4

In the projection apparatus 10A according to the first embodiment, it is determined based on the output from the first sensor 150 that the movement of the projection apparatus 10A has stopped when the state in which the parameter value indicating the movement of the projection apparatus 10A is smaller than the first threshold continues for the first period. The projection apparatus 10A may instead determine based on the output from the second sensor 160 that the movement of the projection apparatus 10A has stopped when the state in which the parameter value indicating the movement of the projection apparatus 10A is smaller than the first threshold continues for the first period.

The same applies to the projection apparatus 10B according to the second embodiment.

### 4-5: Variation 5

In the projection apparatus 10B according to the second embodiment, when a sufficient period elapses in the state in which the movement of the projection apparatus 10B has stopped after the determination section 131B determines that the movement of the projection apparatus 10B has stopped but before the receiving section 137 receives the instruction indicating image distortion correction, the identification made by the identification section 133B and the calculation for the correction made by the correction section 134B may be completed before the receiving section 137 receives the instruction. In this case, at the same time when the receiving section 137 receives the instruction, the correction section 134B can correct the distortion of the image projected by the projector 110.

### 5: Summary of Present Disclosure

The present disclosure is summarized below as additional remarks.

(Additional Remark 1) A method for controlling a projection apparatus configured to project an image onto a projection receiving surface, the method including: determining based on an output from a first sensor that a movement of the projection apparatus stops when a state in which a parameter value indicating the movement is smaller than a first threshold continues for a first period; detecting at least one depth map indicating a distance from a second sensor to each of multiple positions on the projection receiving surface based on an output from the second sensor in at least a portion of the first period; identifying an orientation of the projection apparatus with respect to the projection receiving surface based on the at least one depth map; and correcting distortion of the image based on the orientation when it is determined that the movement stops.

In the control method according to the present embodiment having the configuration described above, measurement of information necessary for performing geometric correction starts by the time when a condition that triggers the geometric correction is satisfied, so that the period required to complete the geometric correction is shorter than in the related art.

More specifically, in the control method according to the present embodiment, the projection apparatus acquires at least one depth map during the first period, which is a period for determining that the movement of the body of the projection apparatus has stopped. The control method according to the present embodiment can thus shorten the period until the orientation of the projection apparatus with respect to the projection receiving surface is identified, as compared with the related art, in which a distance detection pattern used to identify the orientation of the projection apparatus with respect to the projection receiving surface is projected and an image of the distance detection pattern is captured after the first period has elapsed.

(Additional Remark 2) A method for controlling a projection apparatus configured to project an image onto a projection receiving surface, the method including: receiving an instruction indicating correction of distortion of the image via an operation device configured to operate the projection apparatus; detecting at least one depth map indicating a distance from a sensor to each of multiple positions on the projection receiving surface based on an output from the sensor; identifying an orientation of the projection apparatus with respect to the projection receiving surface based on the at least one depth map detected in at least a second period from a first time point at which the instruction is received to a second time point before the first time point; and correcting distortion of the image based on the orientation when the instruction is received via the operation device.

In the control method according to the present embodiment having the configuration described above, measurement of information necessary for performing geometric correction starts by the time when a condition that triggers the geometric correction is satisfied, so that the period required to complete the geometric correction is shorter than in the related art.

More specifically, in the control method according to the present embodiment, the projection apparatus acquires the depth map in the period from the first time point, at which the projection apparatus receives a response instruction indicating correction of the distortion of the image, to the second time point before the first time point, and can then correct the image by using the depth map when the projection apparatus receives the instruction indicating correction of the distortion of the image. The thus configured projection apparatus can shorten the period until the orientation of the projection apparatus with respect to the projection receiving surface is identified, as compared with a case where the projection apparatus starts the acquisition of the depth map after the first time point, at which the projection apparatus receives the instruction.

(Additional Remark 3) The control method according to Additional Remark 1, further including calculating a correction value used to correct the distortion of the image based on a result of the detection of the at least one depth map, the calculation being made in at least a portion of the first period.

In the control method according to the present embodiment having the configuration described above, the correction value is calculated in the first period, so that the period required for the correction of the distortion of the image can be further shortened, as compared with a case where the correction value is calculated after the first period.

(Additional Remark 4) The control method according to Additional Remark 1, wherein detecting the at least one depth map is started from a first point in time at which it is determined that the parameter value is smaller than the first threshold.

In the control method according to the present embodiment having the configuration described above, the projection apparatus does not acquire a depth map before the first point in time at which it is determined that the parameter value is smaller than the first threshold, so that the amount of wasteful data is reduced.

(Additional Remark 5) The control method according to Additional Remark 1, wherein the distortion of the image is corrected based on the orientation when an instruction indicating correction of the distortion of the image is received via an operation device configured to operate the projection apparatus and it is determined that the movement stops.

In the control method according to the present embodiment having the configuration described above, the projection apparatus can correct the image in response to receiving the instruction via the operation apparatus configured to operate the projection apparatus, so that the operability for the user is improved.

(Additional Remark 6) The control method according to Additional Remark 5, wherein a timing at which the distortion of the image is corrected is synchronized with a timing at which the instruction indicating correction of the distortion of the image is received via the operation device configured to operate the projection apparatus.

In the control method according to the present embodiment having the configuration described above, the projection apparatus can correct the distortion at the same time when receiving the instruction, so that the period required for the correction can be further shortened.

(Additional Remark 7) The control method according to Additional Remark 1, further including updating, when first data based on the output from the second sensor before the first period is stored in a memory, the first data to second data based on the output from the second sensor in at least a portion of the first period, wherein detecting the at least one depth map includes detecting the at least one depth map based on the second data.

The control method according to the present embodiment having the configuration described above can prevent the distortion of the image from being corrected based on the first data acquired when the projection apparatus is moving, so that the accuracy of the correction can be improved.

(Additional Remark 8) A projection apparatus including one or more processors and configured to project an image onto a projection receiving surface, wherein the one or more processors are configured to determine based on an output from a first sensor that a movement of the projection apparatus stops when a state in which a parameter value indicating the movement of the projection apparatus is smaller than a first threshold continues for a first period; detect at least one depth map indicating a distance from a second sensor to each of multiple positions on the projection receiving surface based on an output from the second sensor in at least a portion of the first period; identify an orientation of the projection apparatus with respect to the projection receiving surface based on the at least one depth map; and correct distortion of the image based on the orientation when it is determined that the movement stops.

In the projection apparatus according to the present embodiment having the configuration described above, measurement of information necessary for performing geometric correction starts by the time when a condition that triggers the geometric correction is satisfied, so that the period required to complete the geometric correction is shorter than in the related art.

More specifically, in the projection apparatus according to the present embodiment, the projection apparatus acquires at least one depth map during the first period, which is a period for determining that the movement of the body of the projection apparatus has stopped. The projection apparatus according to the present embodiment can thus shorten the period until the orientation of the projection apparatus with respect to the projection receiving surface is identified, as compared with the related art, in which a distance detection pattern used to identify the orientation of the projection apparatus with respect to the projection receiving surface is projected and an image of the distance detection pattern is captured after the first period has elapsed.

What is claimed is:

1. A method for controlling a projection apparatus configured to project an image onto a projection receiving surface, the method comprising:
determining based on an output from a first sensor that a movement of the projection apparatus stops when a state in which a parameter value indicating the movement is smaller than a first threshold continues for a first period;
detecting at least one depth map indicating a distance from a second sensor to each of multiple positions on the projection receiving surface based on an output from the second sensor in at least a portion of the first period;
identifying an orientation of the projection apparatus with respect to the projection receiving surface based on the at least one depth map; and
correcting distortion of the image based on the orientation when it is determined that the movement stops.

2. A method for controlling a projection apparatus configured to project an image onto a projection receiving surface, the method comprising:
receiving an instruction indicating correction of distortion of the image via an operation device configured to operate the projection apparatus;
detecting at last one depth map indicating a distance from a sensor to each of multiple positions on the projection receiving surface based on an output from the sensor;
identifying an orientation of the projection apparatus with respect to the projection receiving surface based on the at least one depth map detected in at least a second period from a first time point at which the instruction is received to a second time point before the first time point; and
correcting distortion of the image based on the orientation when the instruction is received via the operation device.

3. The control method according to claim 1, further comprising calculating a correction value used to correct the distortion of the image based on a result of the detection of the at least one depth map, the calculation being made in at least a portion of the first period.

4. The control method according to claim 1, wherein
detecting the at least one depth map is started from a first point in time at which it is determined that the parameter value is smaller than the first threshold.

5. The control method according to claim 1, wherein
the distortion of the image is corrected based on the orientation when an instruction indicating correction of the distortion of the image is received via an operation device configured to operate the projection apparatus and it is determined that the movement stops.

6. The control method according to claim 5, wherein
a timing at which the distortion of the image is corrected is synchronized with a timing at which the instruction indicating correction of the distortion of the image is received via the operation device configured to operate the projection apparatus.

7. The control method according to claim 1,
further comprising updating, when first data based on the output from the second sensor before the first period is stored in a memory, the first data to second data based on the output from the second sensor in at least a portion of the first period,
wherein detecting the at least one depth map includes detecting the at least one depth map based on the second data.

8. A projection apparatus comprising one or more processors and configured to project an image onto a projection receiving surface, wherein
the one or more processors are configured to
determine based on an output from a first sensor that a movement of the projection apparatus stops when a state in which a parameter value indicating the movement of the projection apparatus is smaller than a first threshold continues for a first period;
detect at least one depth map indicating a distance from a second sensor to each of multiple positions on the projection receiving surface based on an output from the second sensor in at least a portion of the first period;
identify an orientation of the projection apparatus with respect to the projection receiving surface based on the at least one depth map; and
correct distortion of the image based on the orientation when it is determined that the movement stops.
